(19) United States
(12) Patent Application Publication
(10) Pub. No.: US 2019/0186569 A1
(43) Pub. Date: Jun. 20, 2019

(54) Brake Tool

(71) Applicant: Charles ABERNATHY, Midland, TX (US)

(72) Inventor: Charles ABERNATHY, Midland, TX (US)

(21) Appl. No.: 16/212,073

(22) Filed: Dec. 6, 2018

Related U.S. Application Data
(60) Provisional application No. 62/596,091, filed on Dec. 7, 2017.

(51) Int. Cl. F16D 65/08; F16D 49/00; F16D 71/00

(52) U.S. Cl. CPC F16D 65/08; F16D 69/00; F16D 71/00; F16D 49/00

(57) ABSTRACT

A single hand tool and method for removing and installing brake springs and brake shoes in any Class 8 Heavy Truck with 10-Lug Wheels, using 4707, 4709, Q, and Q+ shoes, that requires the use of larger, more robust tooling not associated with the light truck and automotive industry, due to the size of the components used in the manufactured units. The device aids in capturing and extending drum brake main springs and forceful removal of rear springs, and it uses existing parts of the drum brake assembly for leverage.

### BACKGROUND OF THE INVENTION

### Field of the Invention

The present invention relates generally to the field of hand tools used for assisting in removing and installing automotive brake springs and brake shoes. Specifically, the present invention provides a hand tool with which the user can perform three functions which make removal and installation of brake springs and shoes on heavy trucks safer and easier than currently possible.

### Background of the Invention

When servicing drum brake assemblies on heavy duty trucks, the hazard and unpredictability of spring removal can be reduced with use of adequate tools. Two different tools are necessary for efficient servicing of brake drums in Class 8 heavy truck applications. Combining these tools further increases efficiency and safety.

As compared with tools used for smaller commercial vehicles, the forces involved in replacing brakes on a Class 8 heavy truck require more substantial tools for proper, safe, and efficient removal and installation of brake parts

### Description of the Prior Art

A review of the prior art reveals multiple notable tools designed to aid the process of drum brake servicing.

U.S. Pat. No. 7,676,896 issued to James R. CARSCADDEN discloses a tool using a C-shaped gripping member at a distal end of an extended, flattened stem for extending and disconnecting drum brake springs.

U.S. Pat. No. 3,602,973 issued to Samuel G. MATA discloses a double Class 1 lever. When effort closes the tool, it can be used to engage and spread the moveable ends of a pair of brake shoe portions of a motor vehicle brake assembly.

U.S. Pat. No. 3,891,185 issued to Lawrence W. LETT discloses an elongated tool using two closing “spurs” to aid in compression of drum brake springs. The spurs are located at one distal end and a handle is at the other distal end. One spur is intended to remain stationary and the other is intended to be moved in a linear manner while a knob on the handle end is rotated and eventually hold in place.

U.S. Pat. No. 4,870,737 issued to Roger NAVARRO discloses an elongated tool using four static, laterally extending spurs to engage the coiled portion of brake springs to allow for removal or installation.

U.S. Pat. No. 5,003,680 issued to Ivan VESELY and Xaver KREITMAIR discloses an elongated tool which can be used as a first, second, or third class lever. At least one hook member is pivoted on said tool and can swing through an angle of at least ninety degrees in relation to the lever. A perpendicular spur and a second hook are also attached to said tool.

### SUMMARY OF THE INVENTION

A benefit of embodiments of the present invention is, as provided by a single tool of the present invention (as compared to multiple tools in accordance with conventional practice), to facilitate and increase safety of installation and removal of brake springs and brake shoes, in a manner that minimizes safety hazards relative to conventional tools and methods. The tool's flat edges increase stability and allow for it to be used as a lever without rolling.

Another benefit of embodiments of the present invention is to allow the ease of use afforded by purpose of design. This tool is designed specifically for heavy duty truck drum brake assemblies, especially for those on any Class 8 heavy truck with 10-lug wheels using 4707, 4709, Q, and Q+ brake shoes. Dimensions and radiuses incorporated into this design allow adequate fitment on these standard assemblies. Finally, it is an object of this invention to have simple design and operation. This tool contains no moving parts.

This tool has three uses. The first use is for extending and disconnecting main springs from brake shoes. The second use is for disconnecting rear springs from brake shoes. The third use is for extending main springs and separating brake shoes from the S-Cam. These uses are described in detail below.

### BRIEF DESCRIPTION OF THE DRAWINGS

FIG. 1 is a technical drawing of the tool from angle from which the tool's main claw radius is visible (X-axis and Y-axis). This figure gives linear measurements.

FIG. 2 is a technical drawing of the tool from angle from which the tool's main claw radius is visible (X-axis and Y-axis). This figure gives radiuses for curves.

FIG. 3 is a technical drawing of the tool from its Z-axis.

FIG. 4 is a view of the brake tool's clawed end in position for use.

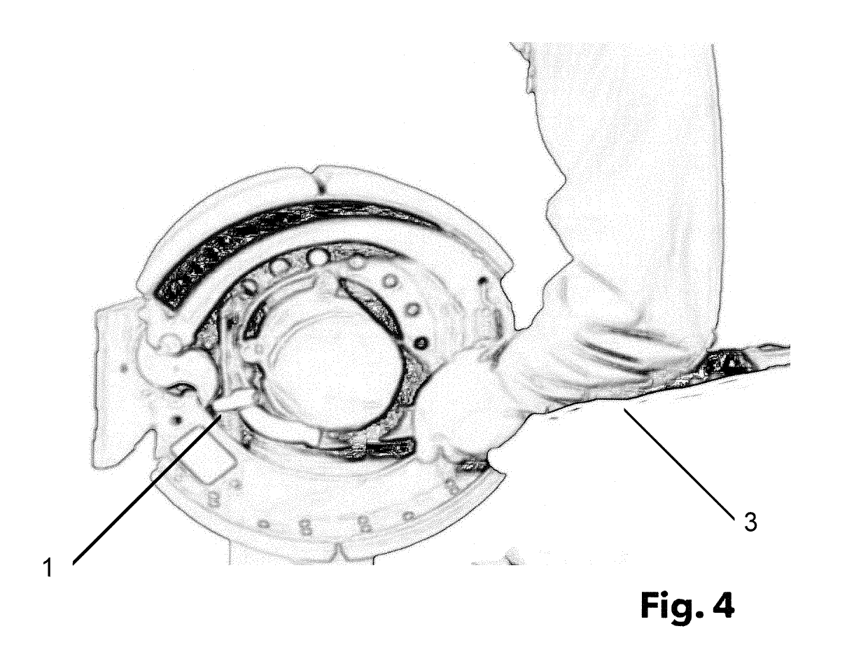

FIG. 5 is a view of the tool being used as a lever, inserted “stinger” end first, to extend the main spring, open a gap between the brake shoe and the S-Cam, and replace the S-Cam roller

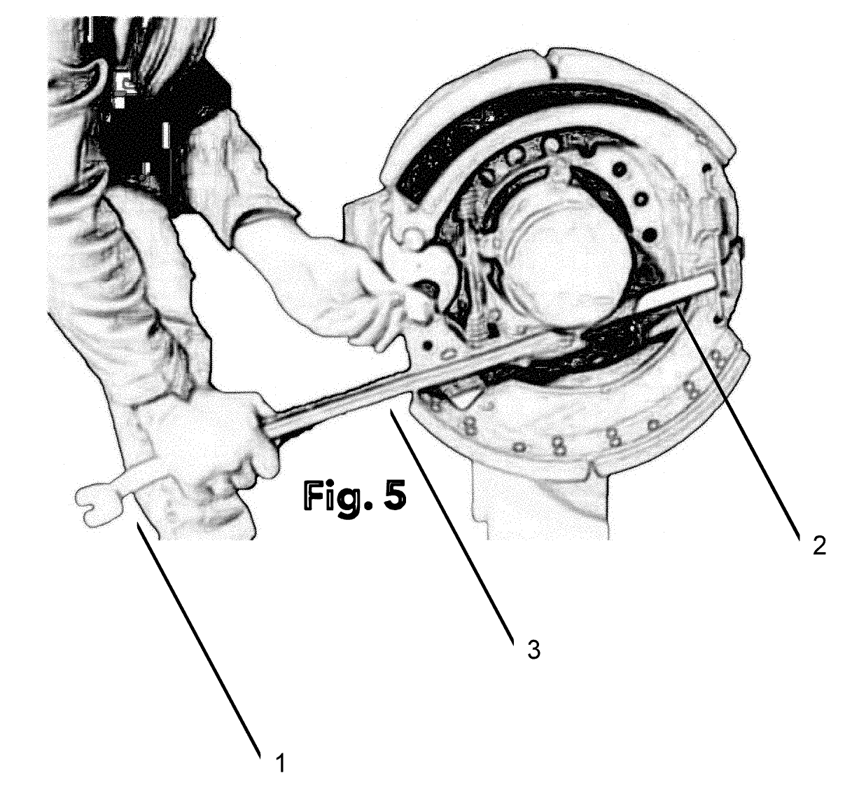

FIG. 6 is a view of the “stinger” end being shoved into the gap between the rear spring and the brake shoe.

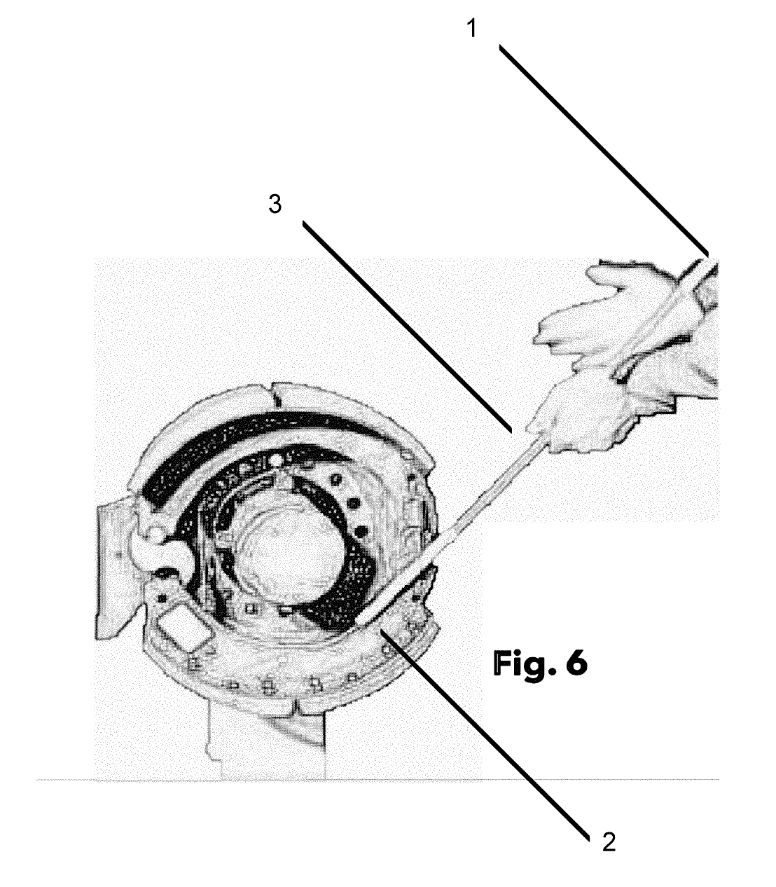

### DETAILED DESCRIPTION OF THE PREFERRED EMBODIMENT

An embodiment of the present inventor's brake tool comprises an elongated member 3 of a predetermined length, generally uniform and predetermined width, and one engagement portion at each end.

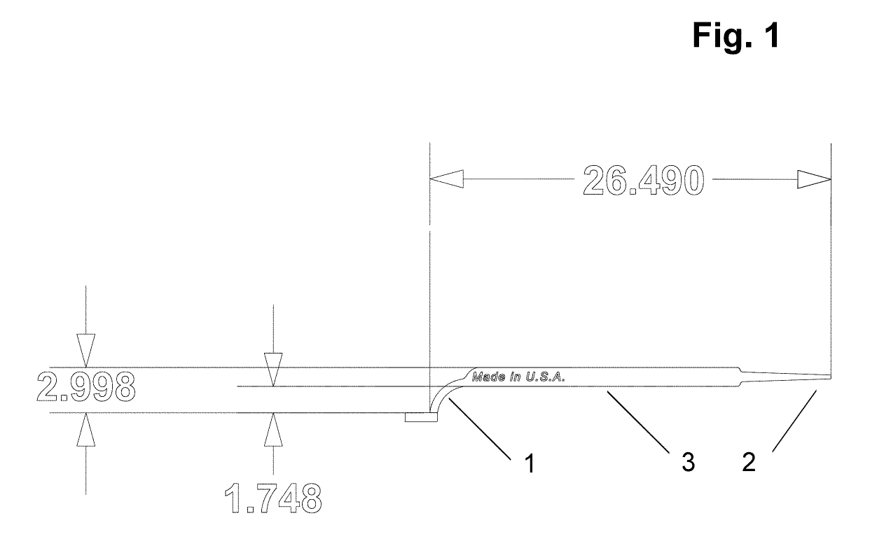

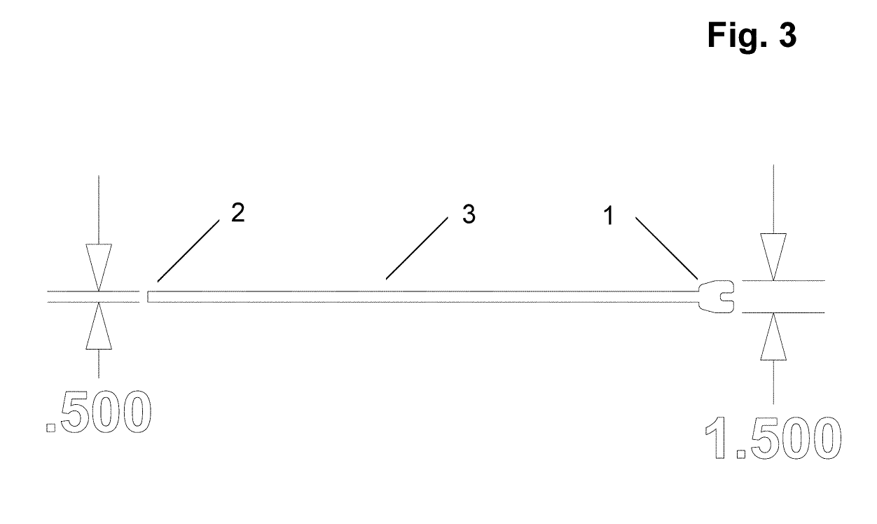

The sides along the tool's elongated member 3 are substantially rectangular. The preferred width of the elongated member 3 as shown in FIG. 1 is 1.25 inches. The preferred width of the elongated member 3 as shown in FIG. 3 is ½ inch.

The first engagement means 1 includes a transition portion of predetermined length, having a predetermined transition radius relative to a point determined by the engagement means. This engagement means is defined at one end of the tool, beyond a transition portion, for engagement of a return spring shaft of a braking mechanism. By placing the clawed portion into position at the drum brake main spring, it can be used as the load-bearing component of a Class 1 lever, meaning that the fulcrum is positioned in the middle, force is applied as effort on one side of the fulcrum, and the load is positioned on the other side of the fulcrum. The tool acts as the lever, the hub acts as the fulcrum, the spring coil is the load, and the user applies the force.

The second engagement means 2 includes a transition portion and a tapered portion of predetermined length. This engagement means is defined at the opposite distalmost end of the tool from the clawed end. When placed into position at the rear springs, it can be used as the load-bearing component of a Class 1 lever. The tool acts as the lever, the brake shoe acts as the fulcrum, the rear spring is the load, and the user applies the force.

The tool's third use is for extending main springs and separating brake shoes from the S-Cam. The tool acts as a Class 2 lever, meaning that the force is applied as effort in between the load and the fulcrum. The hub acts as the fulcrum, the brake shoe is the load, and the user applies the force.

Referring to FIG. 1, the preferred dimension from the end of the first engagement portion to the end of the second engagement portion (total length of tool along X-axis) is 26.490 inches. The preferred total height of the claw's radius (Y-axis) is 1.748 inches. The total height of the tool, including the claw's radius and tool thickness (Y-axis), is 2.998 inches.

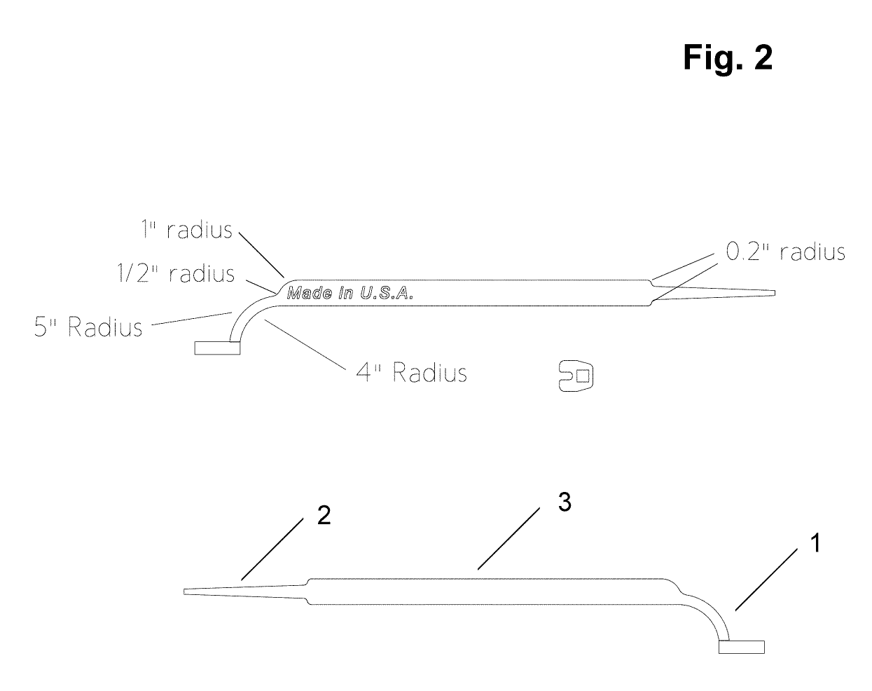

Referring to FIG. 2, the first engagement means 1 includes a preferred outside radius of 5 inches, and an inside radius of 4 inches. The transition portion has radiuses outward from the center and then inward, back to parallel, of a preferred ½ inch and 1 inch, respectively. The second engagement means 2 includes a transition portion with a preferred radius of 0.2 inches inward from center and then an opposite, undefined radius, before tapering gradually to the end of the tool.

Referring to FIG. 3, the first engagement means 1 has a preferred maximum width of 1.500 inches.

1. A brake tool, comprising:
an elongated shaft having a first end, a second end opposite said first end, and a center section;
substantially flat edges along said shaft;
a first engagement portion at said first end of said shaft having a clawed engagement portion at a distalmost end of said shaft and a curved transition portion between said center section of said shaft and said clawed engagement portion; and
a second engagement portion at said second end and configured to have a tapered edge.

2. The apparatus of claim 1 wherein said apparatus is substantially rectangular and its sides measure approximately 1.25″ and 0.5″ wide respectively.

3. A method for servicing a drum brake assembly comprising the steps of:
Selecting a brake tool comprising:
an elongated shaft having a first end, a second end opposite said first end, and a center section;
substantially flat edges along said shaft;
a first engagement portion at said first end of said shaft having a clawed engagement portion at a distalmost end of said shaft and a curved transition portion between said center section of said shaft and said clawed engagement portion; and
a second engagement portion at said second end and configured to have a tapered edge;
disconnecting a main spring of said drum brake assembly from a brake shoe of said drum brake assembly through steps comprising:
inserting said first end into a drum brake assembly from the side of said drum brake assembly opposite an s-cam roller, between the center hub and the bottom brake pad of said drum brake assembly, with said clawed engagement portion facing upward relative to said drum brake assembly when oriented for operation on an upright vehicle;
positioning said brake tool in a manner whereby said clawed engagement portion is placed on top of a main spring's coil of said drum brake assembly, forming said brake tool's load-bearing portion and first point of contact, and said shaft is placed against a center hub of said drum brake assembly, said center hub thereby acting as the fulcrum of said brake tool serving as a class 1 lever, forming said brake tool's second point of contact; and
exerting a force on the effort portion of the class 1 lever in a manner that extends said main spring.

4. The method of claim 2 further comprising the step of moving a brake shoe, comprising the steps of:
inserting said second end of said brake tool into said drum brake assembly, between said center hub and said bottom brake shoe of said drum brake assembly, from aside said main spring
positioning of said brake tool against said center hub for serving as a fulcrum for said brake tool to act as a class 2 lever, forming said class 2 lever's first point of contact, and said shaft is placed against an end of a brake shoe of said drum brake assembly nearest the user, forming the class 2 lever's load-bearing portion and second point of contact; and
exerting a force on the effort portion of said class 2 lever, allowing movement of said brake shoe and thereby extending said main spring and allowing positioning of an s-cam roller.

5. The method of claim 2 further comprising the step of disconnecting a rear spring from a brake shoe of said brake assembly comprising the steps of:
selecting a brake tool comprising:
inserting said second end of said brake shoe into a gap between a rear spring of said drum brake assembly and a brake shoe of said drum brake assembly; and
exerting a force on the effort portion of said brake shoe applied as a class 1 lever, causing force by the load-bearing portion of said brake tool against said rear spring and causing said rear spring to disengage from said brake shoe.

6. The method of claim 3 further comprising the step of disconnecting a rear spring from a brake shoe of said brake assembly comprising the steps of:
Inserting said second end of said brake shoe into a gap between a rear spring of said drum brake assembly and a brake shoe of said drum brake assembly; and
Exerting a force on the effort portion of said brake shoe applied as a class 1 lever, causing force by the load-bearing portion of said brake tool against said rear spring and causing said rear spring to disengage from said brake shoe.
